(19) United States
(12) Patent Application Publication
(10) Pub. No.: US 2023/0206264 A1
(43) Pub. Date: Jun. 29, 2023

(54) OPTIMIZATION METHOD, OPTIMIZATION APPARATUS AND PROGRAM

(71) Applicant: NIPPON TELEGRAPH AND TELEPHONE CORPORATION, Tokyo (JP)

(72) Inventors: Yuya HIKIMA, Tokyo (JP); Masahiro KOJIMA, Tokyo (JP); Yasunori AKAGI, Tokyo (JP); Takeshi KURASHIMA, Tokyo (JP); Hiroyuki TODA, Tokyo (JP)

(73) Assignee: NIPPON TELEGRAPH AND TELEPHONE CORPORATION, Tokyo (JP)

(21) Appl. No.: 18/008,475

(22) PCT Filed: Jun. 10, 2020
(86) PCT No.: PCT/JP2020/022930

§ 371 Date: Dec. 6, 2022

(51) Int. Cl. G06Q 30/0201; G06Q 30/0202

(52) U.S. Cl. CPC G06Q 30/0206; G06Q 30/0202

(57) ABSTRACT

An optimization method according to an embodiment is executed by a computer, the method including: receiving a participation probability function of each of groups participating in a two-sided market, the two-sided market including a first side and a second side, a total number of participants included in the group, a maximum number of participants on the second side with whom the participants can perform a transaction, a set of combinations of groups that can perform a transaction between the two sides, formulating, using the participation probability function, the total number, the maximum number, and the set of combinations, a first optimization problem for determining an optimal price for a participation fee that maximizes a profit of an intermediary of the two-sided market and a number of transactions between the participants, and calculating the optimal price by solving the first optimization problem according to a characteristic of the participation probability function.

### TECHNICAL FIELD

The present invention relates to an optimization method, an optimization apparatus, and a program.

### BACKGROUND ART

With proliferation of information technology in recent years, various two-sided markets have been established. A two-sided market is a market where there exist two sides with different attributes, and participants belonging to each side perform transactions with participants of the other side, and there exist an intermediary for the transactions. Note that the two-sided market is also called a platform. Examples of the two-sided market and the sides thereof include a seller and a consumer in e-commerce, a customer and a driver in taxi hailing, an advertiser and a website in advertising business, a man and a woman, which are users of a mobile application for a matching service between men and women, and the matching service, and a task and a worker in crowdsourcing.

In the two-sided market, a participation fee is charged on the participants by the intermediary. It is of importance for the price setting of this participation fee that the value of the market felt by each participant is determined according to the number of participants on the other side. For example, in the case of e-commerce, the market value for sellers increases with an increase in the number of consumers, because the possibility that a large number of products can be sold increases. On the other hand, the market value for the consumers also increases with an increase in the number of sellers, because the number of selections for purchasable products increases. In addition, a high market value also has the effect of further increasing the market value. This is because the increase in the number of participants due to a high market value provides a further increase in the market value. On the contrary, if the number of participants is small, the value of the market is reduced, as a result of which the number of participants is further reduced, thus resulting in a further reduction in the market value.

For this reason, existing studies have proposed techniques for optimizing the participation fee taking into account the market value and the utility for the participants on the two sides. According to such existing studies, the value and the utility of a market are defined using the number and the type of participants, and a single price is set for the participants of the market. For example, according to NPL 1, a single price is set for each side. For example, according to NPL 2, in side spatial crowdsourcing or the like, a price is set for each area for participants on one side.

### CITATION LIST

### Non Patent Literature

[NPL 1] Andrei Hagiu. Two-sided platforms: Pricing and social efficiency. Available at SSRN 621461, 2004.
[NPL 2] Yongxin Tong, Libin Wang, Zimu Zhou, Lei Chen, Bowen Du, and Jieping Ye. Dynamic pricing in spatial crowdsourcing: A matching-based approach. In SIGMOD Conference, 2018.

### SUMMARY OF THE INVENTION

### Technical Problem

However, since the techniques proposed in the existing studies set a single price, it is not possible to set an optimal price for the participation fee if there is a restriction with regard to a transaction counterparty of each participant. Here, the expression “there is a restriction with regard to a transaction counterparty” means that each participant cannot perform a transaction with all participants on the other side, but can only perform a transaction with some of the participants. This means that there are combinations of participants between which a transaction can be performed.

The techniques proposed in the existing studies do not grasp such combinations, and thus cannot set an optimal price for the participation fee, resulting in a possible reduction in the final number of transactions performed between the participants.

For example, assuming a case where there is a large demand for tasks that can only be performed by men in a crowdsourcing market, this market has higher needs for male workers. However, since the techniques proposed in the existing studies set a single price as the participation fee for each worker, both male and female workers are attracted to the market. This may result in an insufficient amount of tasks achieved due to an insufficient number of male workers, or result in an insufficient amount of tasks for female workers.

For example, in the case where there are workers who can perform various tasks, and workers who can only perform a specific task, setting a single price as the participation fee may cause an outflow of the former workers although the former workers contribute more to an increase in the number of tasks that are finally achieved.

An embodiment of the present invention has been achieved in view of the foregoing, and an object thereof is to determine an optimal price for a participation fee in a two-sided market where there is a restriction with regard to a counterparty with whom each participant can perform a transaction.

### Means for Solving the Problem

In order to attain the above-described object, an optimization method according to an embodiment is executed by a computer, the method including: an inputting step of inputting a participation probability function of each of groups participating in a two-sided market, a total number of participants included in the group, a maximum number of participants on the other side with whom the participants can perform a transaction, a set of combinations of groups that can perform a transaction between the two sides, a formulating step of formulating, using the participation probability function, the total number, the maximum number, and the set of combinations, a first optimization problem for determining an optimal price for a participation fee that maximizes a profit of an intermediary of the two-sided market and a number of transactions between the participants, and an optimizing step of calculating the optimal price by solving the first optimization problem according to a characteristic of the participation probability function.

### Effects of the Invention

It is possible to determine an optimal price for a participation fee in a two-sided market where there is a restriction with regard to a counterparty with whom each participant can perform a transaction.

### BRIEF DESCRIPTION OF DRAWINGS

FIG. 1 is a diagram illustrating an example of combinations between which a transaction can be performed.

FIG. 2 is a diagram illustrating an example of a functional configuration of a price optimization apparatus according to the present embodiment.

FIG. 3 is a flowchart illustrating an example of a flow of price optimization processing according to the present embodiment.

FIG. 4 is a flowchart illustrating an example of a flow of processing for calculating an optimal solution or an approximate solution of an optimization problem according to the present embodiment.

FIG. 5 is a diagram illustrating an example of a hardware configuration of a price optimization apparatus according to the present embodiment.

### DESCRIPTION OF EMBODIMENTS

Hereinafter, an embodiment of the present invention will be described. In the present embodiment, a description will be given of a price optimization apparatus 10 capable of calculating an optimal price for a participation fee for each participant in a two-sided market where there is a restriction with regard to a counterparty with whom each participant can perform a transaction. More specifically, considering groups in which participants are grouped according to their respective attributes, combinations of the participants between which a transaction can be performed are represented by combinations of the groups, and the price for the participation fee for each of the groups is optimized by the price optimization apparatus 10. At this time, an optimization problem having two stages is formulated in which the optimization problem in the first stage is price determination, and the optimization problem in the second stage is a matching problem. An optimal price for the participation fee for each group is calculated by solving the problem. This makes it possible to calculate, as the optimal price, a price that can increase, for example, the profit of the intermediary, and the final number of transactions.

Furthermore, with the price optimization apparatus 10 according to the present embodiment, a lower price is calculated for participants who can perform a transaction with a wide range of counterparties. Accordingly, it is considered that the possibility of the outflow of such participants can be reduced, and the participants will stay in the platform.

### <Technique Proposed in the Existing Studies>

As an example, the technique proposed in NPL 1 listed above will be described. NPL 1 assumes a two-sided market where there are products and consumers (e.g., a smartphone application market, e-commerce, a video game market, etc.), and a participation fee P^{D} for products that maximizes the profit of the service intermediary, and a participation fee P^{U} for consumers are determined in the following manner.

Each consumer has a parameter θ∈[0,θ_{H}] of the cost required to participate in the market, and the cumulative distribution function is represented as F(θ). The utility that the consumer obtains by participating in the market can be represented by the following formula (1):

u(n)−P^{U}−θ (1)

where n is the number of products (i.e., the number of participating products), and u(n) is the utility that the consumer feels about the number of products. Accordingly, for θₘ that satisfies u(n)−P^{U}=θₘ, the number of participating consumers is F(θₘ). This is because the number of consumers that satisfies u(n)−P^{U}−θₘ≥0, i.e., that makes utility 0 or more is F(θₘ).

Next, it is assumed that ϕℑ[0, ϕ_{H}] is the cost for a given product to participate in (e.g., to be displayed) in a two-sided market. In a product that can participate in the two-sided market, a cumulative distribution for ϕ is represented as H(ϕ). At this time, for the n number of products participating in the two-sided market, the equation shown in the following formula (2) holds.

H(π(n)·F(θₘ)−P^{D})=n (2)

where π(n) represents the profit of each product per consumer. The equation shown in the above formula (2) indicates that the number of sellers that makes π(n)·F(θₘ)−P^{D}−ϕ, which represents the profit of the seller of the product, be 0 or more matches the number n of sellers participating in the two-sided market.

From the above formulas (1) and (2), the profit of the intermediary of the two-sided market can be represented as the following formula (3).

Π^{P}=P^{U}·F(θₘ)+n·P^{D}=(u(n)+n·π(n)−θₘ)−F(θₘ)−n·H⁻¹⁽n) (3)

From an optimality condition for a first differential for (ϕₘ,n), an optimal (ϕₘ*, n*) can be determined by the above formula (3). Therefore, optimal P^{U} and P^{D} are determined by the (θₘ*, n*) and the above formulas (1) and (2).

In this manner, the technique proposed in NPL 1 sets a single price for the participation fee for each side. That is, the techniques proposed in the existing studies, including NPL 1, do not differentiate between individual participants or participating groups. Therefore, in the present embodiment, an optimization problem for determining a price for the participation fee for each individual is formulated taking into account the final amount of transactions between participants.

The optimization problem formulated in the present embodiment has the following difficulties.
Since the objective function includes a huge number of bipartite graph matchings, the calculation for the differential value and the objective function value cannot be performed in polynomial time.
Depending on the definition of the participation probability function for the price for each participant, the optimization problem becomes nonconvex.

Due to these difficulties, an enormous amount of computation is required for an exact solution, and an L-shaped method, which is a conventional technique for an optimization problem including uncertainty, and a conventional technique in which an implicit enumeration method and an L-shaped are combined, and the like cannot be applied to the optimization problem formulated in the present embodiment. Therefore, the present embodiment proposes, for the formulated optimization problem, a computationally low complex approximate solution that utilizes properties unique to the problem.

### <Theoretical Configuration of the Present Embodiment>

A theoretical configuration when an optimal price for a participation fee for each participant is calculated by the price optimization apparatus 10 according to the present embodiment will be described.

### <<Formulation of Optimization Problem That Maximizes Profit of Service Intermediary and Value of Market>>

First, two sides exist in a two-sided market. Also, n+m groups exist into which participants who can participate in the two-sided market are classified. At this time, the index for identifying each group is represented as i, i=1, 2, . . . , n belong to one side, and i=n+1, n+2, . . . , n+m belong to the other side. A group is created by classifying (grouping) participants according to their attributes. Examples of the group include classifications of participants according to their attributes, including, for example, the age, the sex, and what each participant seeks for the participants on the other side. Note that the present embodiment is similarly applicable to a case where the number of persons constituting each group is one, and an index i is given to each participant.

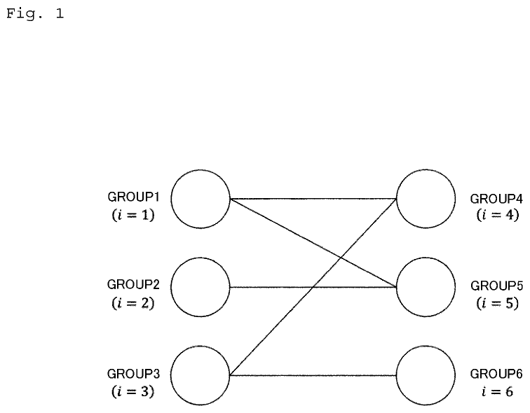

The participants in each group i have a participation probability Sᵢ(x) having a participation fee x as a variable. A total number of participants belonging to each group i is represented as Kᵢ, and the maximum value of the number of participants on the other side with whom each participant can perform a transaction is represented as Oᵢ. In addition, a set of combinations of groups between which a transaction can be performed is represented as E∈{1, 2, . . . , n}×{n+1, n+2, . . . , n+m}. An example of the combinations of groups between which a transaction can be performed when n=3, m=3 is shown in FIG. 1. The example shown in FIG. 1 indicates a case where E={(1,4),(1,5),(2,5),(3,4),(3,6)}.

Note that the two sides of the two-sided market correspond to, for example, a man and a woman in the case of a matching service between men and women, and a product and a consumer in the case of e-commerce. The maximum value of the number of participants on the other side with whom each participant can perform a transaction corresponds to, for example, the maximum number of persons with whom a man or a woman can have a meeting with a view to marriage in the case of a matching service between men and women, and the available quantity of products or the maximum number of searches made by consumers in the case of e-commerce.

At this time, when a price vector having, as an element, the price for the participation fee set for each participant is represented as p∈R^{n+m}, the purpose is to solve the optimization problem shown in the following formula (4). Note that the ith element pᵢ of the price vector p represents the price for the participation fee set for participants belonging to the group i. R represents a set of all real numbers.

$$\begin{matrix}[ Math . 1 ] & \\ {max}_{p} f ( p ) + α \cdot g ( p ) \\ s . t . p ∈ {ℝ}^{n + m} & ( 4 )\end{matrix}$$

where f (p) represents the profit that the intermediary of the two-sided market can obtain, g(p) represents the expected value of the number of transactions achieved, and the definitions thereof will be described later. α represents a parameter for determining the specific gravities of f(p) and g(p).

Note that the price vector p may include an element that takes a negative value. An element that takes a negative value represents the price paid by the intermediary of the two-sided market to the participants of the group corresponding to the element. For example, this corresponds to a case where a point is given as a privilege for participating.

The Definition of a Profit f(p) that the Intermediary of the Two-Sided Market can Obtain

First, a∈[0,1]^{n+m} is a vector representing the participation rate for each group. Since the participation rate of each group i is probabilistically determined by the given participation fee pᵢ, a represents the probability vector. Here, the profit that the intermediary of the two-sided market can obtain is defined based on the expected profit, using the following formula (5)

$$\begin{matrix}[ Math . 2 ] & \\ f ( p ) := {{\sum }^{n + m}}_{i = 1} {p}_{i} \cdot {K}_{i} \cdot {𝔼}_{{a}_{i} ∼ Pr ( \cdot \vert {p}_{i} )} [ {a}_{i} ] = {{\sum }^{n + m}}_{i = 1} {p}_{i} \cdot {K}_{i} \cdot {s}_{i} ( {p}_{i} ) & ( 5 )\end{matrix}$$

Note that aᵢ represents the ith element (i.e., the element representing the participation rate of the group i) of the vector a.

The Definition of the Number of Transactions g(p) Achieved

g(p) is defined as the maximization problem of the number of transactions in a bipartite graph. When each participant has determined whether or not to participate in a specific p, the number of transactions is maximized by solving the optimization problem shown in the following formula (6).

$$\begin{matrix}[ Math . 3 ] & \\ {max}_{𝓏} {\sum }_{( i , j ) ∈ E} {𝓏}_{i j} s . t . {\sum }_{( i , j ) ∈ δ ( i )} {𝓏}_{i j} \leq {a}_{i} \cdot {K}_{i} \cdot {O}_{i} ( i = 1 , 2 , … , n + m ) {𝓏}_{ij} ∈ ℤ ( ( i , j ) ∈ E ) & ( 6 )\end{matrix}$$

where δ(i) represents a set in which combinations including i are assembled for each element of a set E of combinations between which a transaction can be performed. zᵢⱼ represents the number of matchings between the group i and a group j, and the objective function (i.e., the sum of zᵢⱼ for each (i,j)∈E)) represents the total number of transactions. The first constraint is such that the maximum amount of transactions that each group can perform does not exceed the total number of transactions assigned to the group. Note that the constraint is the portion described after s.t.

When an optimum value of the optimization problem shown in the above formula (6) is defined as X(a), the expected value g(p) of the number of transactions achieved can be defined by the following formula (7).

$$\begin{matrix}[ Math . 4 ] & \\ g ( p ) := {𝔼}_{a ∼ Pr ( \cdot \vert p )} [ X ( a ) ] \\ where & ( 7 )\end{matrix}$$

$$Pr ( a \vert p ) : = {\prod }_{i = 1}^{n} \{ {{S}_{i} ( {p}_{i} )}^{{a}_{i}} {( 1 - {S}_{i} ( {p}_{i} ) )}^{( 1 - a )} \} \qquad [ Math . 5 ]$$

### <<Solution of Optimization Problem Shown in Formula (4)>>

By solving the optimization problem shown in the above formula (4), it is possible to determine an optimal price for the participation fee set for each participant. Any optimization technique can be used as long as an optimal solution of the optimization problem shown in the formula (4) or an approximate solution that achieves a good objective function value can be derived. For example, the solution can be obtained using a genetic algorithm, Bayesian optimization, or the like, or an algorithm or the like that is newly proposed from now on may be used.

However, at present, there is no conventional technique that can solve the optimization problem shown in the above formula (4) fast, and therefore an approximate solution is proposed below. After finishing a common procedure 1-1, this approximate solution branches to one of procedure 1-2a, 1-2b, and 1-2c according to the characteristics of the participation probability function Sᵢ.

Procedure 1-1: Approximation of the Function g(p)

In order to obtain an approximation value of the function g(p), the optimization problem shown in the following formula (8) is considered.

$$\begin{matrix}[ Math . 6 ] & \\ {max}_{𝓏} {\sum }_{( i , j ) ∈ E} {𝓏}_{i j} s . t . {\sum }_{( i , j ) ∈ δ ( i )} {𝓏}_{i j} \leq {K}_{i} \cdot {S}_{i} ( {p}_{i} ) \cdot {O}_{i} ( i = 1 , 2 , … , n + m ) {𝓏}_{ij} ∈ ℤ ( ( i , j ) ∈ E ) & ( 8 )\end{matrix}$$

where, as described above, Sᵢ(pᵢ) represents the probability that the participants belonging to the group i participate in the market.

When an optimum value for the price vector p of the optimization problem shown in the above formula (8) is represented as \hat{ }g(p) (precisely, the symbol hat “\hat{ }” is written directly above g), \hat{ }g(p) is expected to be an approximation value of g(p).

Accordingly, by using \hat{ }g(p) in place of g(p) in the optimization problem shown in the above formula (4), it is possible to obtain the optimization problem shown in the following formula (9)

$$\begin{matrix}[ Math . 7 ] & \\ {max}_{p , 𝓏} {\sum }_{i = 1}^{n + m} {K}_{i} \cdot {p}_{i} \cdot {S}_{i} ( {p}_{i} ) + {\sum }_{( i , j ) ∈ E} {𝓏}_{i j} s . t . {\sum }_{( i , j ) ∈ δ ( i )} {𝓏}_{ij} \leq {K}_{i} \cdot {S}_{i} ( {p}_{i} ) \cdot {O}_{i} ( i = 1 , 2 , … , n : + m ) p ∈ {ℝ}^{n + m} {𝓏}_{ij} ∈ ℝ ( ( i , j ) ∈ E ) & ( 9 )\end{matrix}$$

By solving the optimization problem shown in the formula (9), it is possible to obtain an approximate solution of the optimization problem shown in the above formula (4). Therefore, in the following, a method for solving the optimization problem shown in the formula (9) will be described.

Procedure 1-2a: Solution of the Optimization Problem Shown in the Formula (9) when the Participation Probability Sᵢ is Represented as a Linear Function with Upper and Lower Bounds

It is assumed that, using certain cᵢ, dᵢ, pᵢk, and the participation probability Sᵢ(x) can be represented as

$${S}_{i} ( x ) = \{ \begin{matrix}{L}_{i} ( x \leq {p}_{i}^{k} ) \\ - {c}_{i} \cdot x + {d}_{i} ( {p}_{i}^{k} \leq x \leq {p}_{i}^{u} ) \\ 0 ( x \geq {p}_{i}^{u} )\end{matrix} \qquad [ Math . 8 ]$$

where cᵢ is positive. p^{k} represents a vector having pᵢ^{k} as the ith element, and p^{u} represents a vector having pᵢ^{u} as the ith element.

At this time, it can be easily shown that an optimal solution of the optimization problem shown in the above formula (9) is p^{k}≤p≤p^{u}, the optimization problem shown in the formula (9) can be described as the following formula (10).

$$\begin{matrix}[ Math . 9 ] & \\ {max}_{p , 𝓏} {\sum }_{i = 1}^{n + m} {K}_{i} \cdot {p}_{i} \cdot ( - {c}_{i} \cdot {p}_{i} + {b}_{i} ) + {\sum }_{( i , j ) ∈ E} {𝓏}_{ij} s . t . {\sum }_{( i , j ) ∈ δ ( i )} {𝓏}_{ij} \leq {K}_{i} \cdot ( - {c}_{i} \cdot {p}_{i} + {d}_{i} ) \cdot {O}_{i} ( i = 1 , 2 , … , n + m ) \\ {p}^{k} \leq p \leq {p}^{u} {𝓏}_{i j} ∈ ℝ ( ( i , j ) ∈ E ) & ( 10 )\end{matrix}$$

The optimization problem shown in the above formula (10) is a quadratic programming problem, and thus can be solved fast by using various interior point methods.

Procedure 1-2b: Solution of Optimization Problem Shown in the Formula (9) when the Function 1-Sᵢ(x) is a Monotone Hazard Rate Function

When the following assumption holds for the participation probability Qᵢ(x): =1−Sᵢ(x), Qᵢ(x) is a Monotone hazard rate function for x.

### Assumption:

$$\frac{{Q}_{i}^{′} ( x )}{1 - {Q}_{i} ( x )} \qquad [ Math . 10 ]$$

is monotonically non-increasing with respect to x Note that Q₁′(x) is a function (derivative) obtained by differentiating Qᵢ(x) with respect to x.

The above-described assumption is a relatively weak assumption that also includes that Qᵢ is a cumulative distribution function or the like of a normal distribution, a uniform distribution, or an exponential distribution. Under this assumption, (x+β)·Sᵢ(x) being a concave function holds for any constant β. The approximate solution used at this time will be described below.

First, the first constraint on the optimization problem shown in the above formula (9) is such that an equation always holds in an optimal solution p*, and therefore an optimal solution of the optimization problem shown in the following formula (11) is an optimal solution of the optimization problem shown in the above formula (9).

$$\begin{matrix}[ Math . 11 ] & \\ {max}_{p , z} {\sum }_{i = 1}^{n + m} {K}_{i} \cdot ( {p}_{i} + α \cdot {O}_{i} ) \cdot {S}_{i} ( {p}_{i} ) s . t . {\sum }_{( i , j ) ∈ δ ( i )} {𝓏}_{i j} = {K}_{i} \cdot {S}_{i} ( {p}_{i} ) \cdot {O}_{i} ( i = 1 , 2 , … , n + m ) {𝓏}_{i j} ∈ ℝ ( ( i , j ) ∈ E ) & ( 11 )\end{matrix}$$

Here, since (x+β) Sᵢ(x) is a concave function for any constant β, the objective function (i.e., the sum of Kᵢ·(pᵢ+α·O₁)·Sᵢ(pᵢ)) of the optimization problem shown in the above formula (11) is a concave function. Therefore, the above formula (11) can be considered as a maximization problem of a concave function on a nonconvex set.

Although the optimization problem shown in the above formula (11) is a nonconvex programming problem, the optimization problem has a good characteristic that the objective function is concave, and thus can be efficiently solved using various heuristic techniques or approximate solutions. For example, the function under the first constraint is subjected to piecewise linear approximation, and is optimized using a branch and bound method. In that case, due to the objective function being a concave function, it is possible to perform efficient calculation using more stringent upper and lower bounds.

Procedure 1-2c: Solution of the Optimization Problem Shown in the Formula (9) when the Participation Probability Sᵢ is a Function Other than Those Described Above

When the participation probability Sᵢ is a general function that does not corresponds to the conditions 1-2a and 1-2b described above (i.e., in the case where the participation probability Sᵢ cannot be represented by a linear function with upper and lower bounds, and 1-Sᵢ(x) is not a Monotone hazard rate function), the optimization problem shown in the above formula (9) is a nonconvex programming problem having a nonconcave objective function and a nonconvex executable set. Accordingly, it is possible to obtain an optimal solution or an approximate solution of the optimization problem shown in the above formula (9) by using a heuristic solution such as Bayesian optimization.

In the present embodiment, a case is described where an optimal price for the participation fee for each participant is calculated in a two-sided market where there is a restriction with regard to a counterparty with whom each participant can perform a transaction. However, the present invention is not limited thereto, and can be applied to any problem that can result in the optimization problem shown in the above formula (4).

### <Functional Configuration of Price Optimization Apparatus 10>

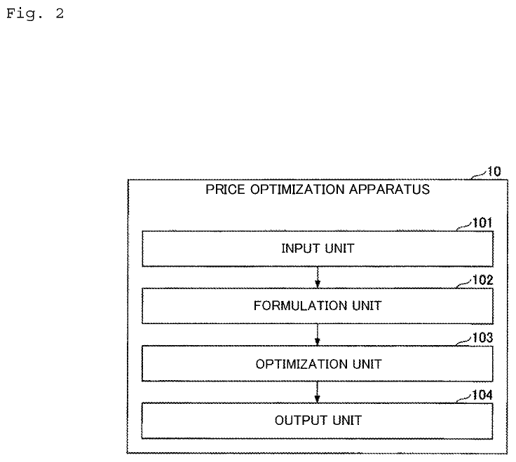

Next, a functional configuration of a price optimization apparatus 10 according to the present embodiment will be described with reference to FIG. 2. FIG. 2 is a diagram showing an example of the functional configuration of the price optimization apparatus 10 according to the present embodiment.

As shown in FIG. 2, the price optimization apparatus 10 according to the present embodiment includes an input unit 101, a formulation unit 102, an optimization unit 103, and an output unit 104.

The input unit 101 inputs various parameters (the participation probability function Sᵢ(x), the total number Kᵢ of participants, the maximum number Oᵢ of participants on the other side that can be matched, and the set E of combinations between which a transaction can be performed) given to the price optimization apparatus 10. Note that the input unit 101 may input these various parameters from any input source. For example, the input unit 101 may input these various parameters by reading the parameters from an auxiliary storage device or the like, or receiving the parameters from another device or the like connected thereto via a communication network, or by receiving input operations performed by a user or the like.

The formulation unit 102 formulates the optimization problem shown in the above formula (4), using the various parameters that have been input by the input unit 101.

The optimization unit 103 calculates an optimal solution or an approximate solution of the optimization problem shown in the formula (4), formulated by the formulation unit 102. At this time, the optimization unit 103 transforms the optimization problem shown in the formula (4) into the optimization problem shown in the formula (9), and thereafter calculates an optimal solution or an approximate solution by any of procedure 1-2a, 1-2b, and 1-2c according to the characteristics of the participation probability function Sᵢ(x).

The output unit 104 outputs the optimal solution or the approximate solution (i.e., a price vector p having, as an element, a price pᵢ set for the participants of each group i) calculated by the optimization unit 103. Note that the output unit 104 may output the optimal solution or the approximate solution to any output destination. For example, the output unit 104 may output (save) the optimal solution or the approximate solution to an auxiliary storage device or the like, may output (transmit) the optimal solution or the approximate solution to another device connected thereto via a communication network or the like, or may output (display) the optimal solution or the approximate solution to a display device such as a display.

In the example shown in FIG. 2, the functional units are included in a single price optimization apparatus 10. However, the present invention is not limited thereto, and a plurality of apparatuses may include the functional units in a distributed manner. For example, two apparatuses, namely, a formulation apparatus and an optimization apparatus, may exist, and the formulation apparatus may include the formulation unit 102, and the optimization apparatus may include the optimization unit 103.

### <Flow of Price Optimization Processing>

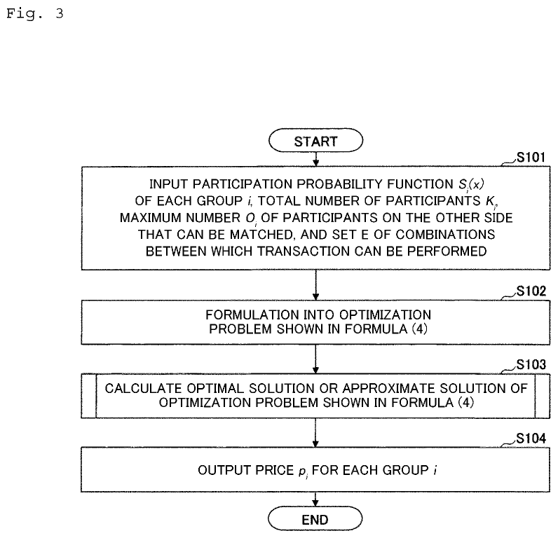

Next, a flow of price optimization processing executed by the price optimization apparatus 10 according to the present embodiment will be described with reference to FIG. 3. FIG. 3 is a flowchart illustrating an example of a flow of price optimization processing according to the present embodiment.

First, the input unit 101 inputs the various parameters (i.e., the participation probability function Sᵢ(x), the total number Kᵢ of participants, the maximum number Oᵢ of participants on the other side that can be matched, and the set E of combinations between which a transaction can be performed) given to the price optimization apparatus 10 (step S101).

Next, the formulation unit 102 formulates the optimization problem shown in the above formula (4), using the various parameters that have been input in step S101 described above (step S102).

Next, the optimization unit 103 calculates an optimal solution or an approximate solution of the optimization problem shown in the formula (4), formulated in step S102 described above (step S103). The details of the flow of the processing in step S103 will be described later.

Then, the output unit 104 outputs the optimal solution or the approximate solution (i.e., a price vector p having, as an element, a price pᵢ set for the participants of each group i) calculated in step S103 described above (step S104).

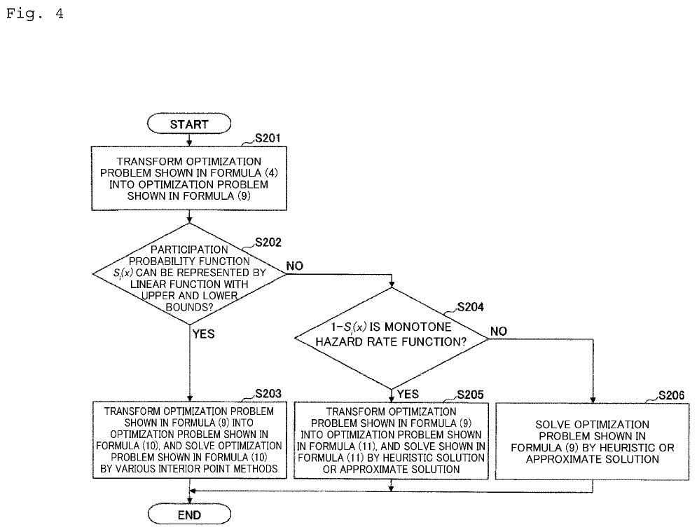

Here, the flow of the processing for calculating the optimal solution or the approximate solution of the optimization problem shown in the formula (4) in step S103 described above will be described with reference to FIG. 4. FIG. 4 is a flowchart illustrating an example of the flow of processing for calculating an optimal solution or an approximate solution of the optimization problem according to the present embodiment.

First, the optimization unit 103 transforms the optimization problem shown in the formula (4), formulated in step S102 described above, into the optimization problem shown in the above formula (9) (step S201). That is, the optimization unit 103 transforms the optimization problem shown in the formula (4) into the optimization problem shown in the formula (9) by procedure 1-1 described above.

Next, the optimization unit 103 determines whether or not the participation probability function Sᵢ(x) that has been input in step S101 described above can be represented by a linear function with upper and lower bounds (step S202).

If it is determined in step S202 above that the participation probability function Sᵢ(x) can be represented by a linear function with upper and lower bounds (YES in step S202), the optimization unit 103 calculates an optimal solution by procedure 1-2a described above (step S203). That is, the optimization unit 103 calculates the optimal solution by transforming the optimization problem shown in the formula (9) into the optimization problem shown in the formula (10), and thereafter solving the optimization problem shown in the formula (10) by various interior point methods.

On the other hand, if it is not determined in step S202 described above that the participation probability function Sᵢ(x) can be represented by a linear function with upper and lower bounds (NO in step S202), the optimization unit 103 determines whether or not 1-Sᵢ(x) is a Monotone hazard rate function (step S204).

If it is determined in step S204 described above that 1-Sᵢ(x) is a Monotone hazard rate function (YES in step S204), the optimization unit 103 calculates an optimal solution or an approximate solution by procedure 1-2b described above (step S205). That is, the optimization unit 103 calculates the optimal solution or the approximate solution by transforming the optimization problem shown in the formula (9) into the optimization problem shown in the formula (11), and thereafter solving the optimization problem shown in the formula (11) by a heuristic solution or an approximate solution.

On the other hand, if it is not determined in step S204 that 1-Sᵢ(x) is a Monotone hazard rate function (NO in step S204), the optimization unit 103 calculates an optimal solution or an approximate solution by procedure 1-2c described above (step S206). That is, the optimization unit 103 calculates the optimal solution or the approximate solution by solving the optimization problem shown in the formula (9) by a heuristic solution such as Bayesian optimization.

### <Hardware Configuration>

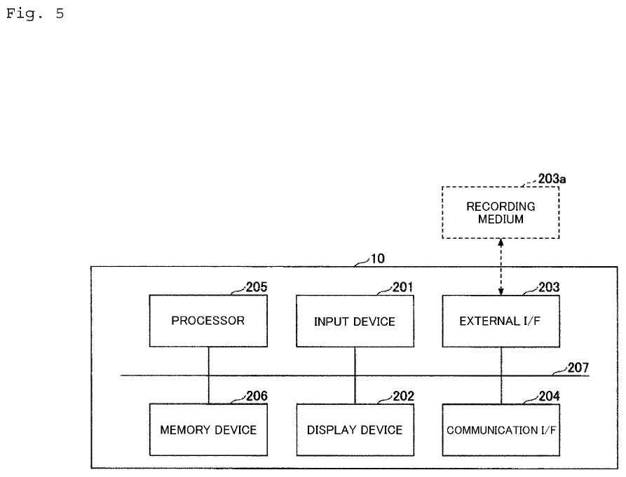

Finally, a hardware configuration of the price optimization apparatus 10 according to the present embodiment will be described with reference to FIG. 5. FIG. 5 is a diagram showing an example of the hardware configuration of the price optimization apparatus 10 according to the present embodiment.

As shown in FIG. 5, the price optimization apparatus 10 according to the present embodiment is implemented by a general computer or computer system, and includes an input device 201, a display device 202, an external I/F 203, a communication I/F 204, a processor 205, and a memory device 206. These pieces of hardware are communicably connected to each other via a bus 207.

The input device 201 is a keyboard, a mouse, a touch panel, or the like, for example. The display device 202 is a display or the like, for example. Note that the price optimization apparatus 10 need not use at least one of the input device 201 and the display device 202.

The external I/F 203 is an interface with an external device such as a recording medium 203a. The price optimization apparatus 10 can perform reading, writing, and the like to and from the recording medium 203a via the external I/F 203. For example, one or more programs for implementing the functional units (the input unit 101, the formulation unit 102, the optimization unit 103, and the output unit 104) of the price optimization apparatus 10 may be stored in the recording medium 203a. Examples of the recording medium 203a include a Compact Disc (CD), a Digital Versatile Disk (DVD), an Secure Digital (SD) memory card, a Universal Serial Bus (USB), and a memory card.

The communication I/F 204 is an interface for connecting the price optimization apparatus 10 to a communication network. Note that the one or more programs for implementing the functional units of the price optimization apparatus 10 may be obtained (downloaded) from a predetermined server device via the communication I/F 204.

The processor 205 is any of various arithmetic units such as a Central Processing Unit (CPU) and a Graphics Processing Unit (GPU), for example. The functional units of the price optimization apparatus 10 can be implemented, for example, by processing for causing the processor 205 to execute the one or more programs stored in the memory device 206.

The memory device 206 is any of various storage devices such as a Hard Disk Drive (HDD), a Solid State Drive (SSD, a Random Access Memory (RAM), a Read Only Memory (ROM), and a flash memory, for example.

By having the hardware configuration shown in FIG. 5, the price optimization apparatus 10 according to the present embodiment can implement the above-described price optimization processing. Note that the hardware configuration shown in FIG. 5 is merely an example, and the price optimization apparatus 10 may have another hardware configuration. For example, the price optimization apparatus 10 may include a plurality of processors 205, and may include a plurality of memory devices 206.

The present invention is not limited to the embodiment specifically disclosed, and various modifications and alterations, and combinations with known techniques can be made without departing from the description in the claims.

### REFERENCE SIGNS LIST

10 Price optimization apparatus
101 Input unit
102 Formulation unit
103 Optimization unit
104 Output unit
201 Input device
202 Display device
203 External I/F
203a Recording medium
204 Communication I/F
205 Processor
206 Memory device
207 Bus

1. An optimization method executed by a computer, the method comprising:
receiving a participation probability function of each of groups participating in a two-sided market, the two-sided market including a first side and a second side, a total number of participants included in the group, a maximum number of participants on the second side with whom the participants can perform a transaction, a set of combinations of groups that can perform a transaction between the two sides,
formulating, using the participation probability function, the total number, the maximum number, and the set of combinations, a first optimization problem for determining an optimal price for a participation fee that maximizes a profit of an intermediary of the two-sided market and a number of transactions between the participants, and
calculating the optimal price by solving the first optimization problem according to a characteristic of the participation probability function.

2. The optimization method according to claim 1,
wherein the calculating calculates the optimal price by transforming the first optimization problem into a second optimization problem using an approximation value of a function representing the number of transactions, and solving the second optimization problem.

3. The optimization method according to claim 2,
wherein, assuming that an index representing each of the groups is i, and a participation probability function of a group i is Sᵢ(x),
the calculating, in a case where the participation probability function Sᵢ(x) can be represented by a linear function with upper and lower bounds, calculates the optimal price by transforming the second optimization problem into a quadratic programming problem, and solving the quadratic programming problem, and,
in a case where each of functions represented by 1-Sᵢ(x) is a Monotone hazard rate function, calculates the optimal price by transforming the second optimization problem into an optimization problem of a concave function on a nonconvex set, and solving the optimization problem of the concave function on the nonconvex set.

4. The optimization method according to claim 3,
wherein the calculating, in a case where the participation probability function Sᵢ(x) cannot be represented by the linear function with upper and lower bounds and each of functions represented by 1-Sᵢ(x) is not the Monotone hazard rate function, calculates the optimal price by solving the second optimization problem by a heuristic technique including Bayesian optimization.

5. An optimization apparatus comprising:
a processor, and
a memory storing program instructions that cause the processor to:
receive a participation probability function of each of groups participating in a two-sided market, the two-sided market including a first side and a second side, a total number of participants included in the group, a maximum number of participants on the second side with whom the participants can perform a transaction, a set of combinations of groups that can perform a transaction between the two sides,
formulate, using the participation probability function, the total number, the maximum number, and the set of combinations, a first optimization problem for determining an optimal price for a participation fee that maximizes a profit of an intermediary of the two-sided market and a number of transactions between the participants, and
calculate the optimal price by solving the first optimization problem according to a characteristic of the participation probability function.

6. A non-transitory computer-readable storage medium that stores therein a program for causing a computer to execute the optimization method of claim 1.
